(19) United States
(12) Patent Application Publication
(10) Pub. No.: US 2025/0128878 A1
(43) Pub. Date: Apr. 24, 2025

(54) LOCKING CONTAINERS AND RELATED CLOSURES

(71) Applicant: Pulli Inc., San Francisco, CA (US)

(72) Inventors: Michael Belluomini, Gaithersburg, MD (US); David Lari, San Francisco, CA (US); Jason Kuo, San Francisco, CA (US)

(21) Appl. No.: 18/919,943

(22) Filed: Oct. 18, 2024

Related U.S. Application Data
(60) Provisional application No. 63/591,176, filed on Oct. 18, 2023.

(51) Int. Cl. B65F 1/12; B65F 1/16

(52) U.S. Cl. CPC B65F 1/12; B65F 1/163; B65F 2210/148

(57) ABSTRACT

A container comprising: doors, a body, a tray, a cover, a lid, a trash bag compartment, and a closure or vertical locking mechanism. The closure has an engaged or locked position and a disengaged or unlocked position. The closure is operatively connected to the cover such that when the cover is in an open position, the closure is in the disengaged position. When the cover is closed, the closure is in an engaged position. The closure is also operatively connected to one or more of the doors such that when the closure is in an engaged position, the doors are prevented from being opened. When the closure is in a disengaged position the doors are allowed to be opened.

### CROSS-REFERENCE PARAGRAPH

This non-provisional patent application claims the benefit of and priority to, U.S. Provisional Patent Application No. 63/591,176, titled ADAPTIVE WASTE RECEPTACLES AND CLOSURES THEREFORE, filed on Oct. 18, 2023, the contents of which are incorporated by reference as if set forth below in its entirety.

### FIELD OF USE

The present disclosure relates, in general, to waste receptacles. More specifically, the present disclosure relates to an adaptive waste receptacle that is configured to have contents removed laterally, as opposed to vertically, and that has a closure, lock, or locking mechanism for use with horizontally opening doors.

### BACKGROUND

Generally, most standard kitchen waste bags are around 13 gallons, so 12-16-gallon waste receptacles are frequently used in home kitchens. A typical waste receptacle may range anywhere from twenty-three (23) inches in height to twenty-seven (27) inches in height and contains waste bag or liner as they are filled. A typical 13-gallon kitchen waste bag may weigh as much as fifteen (15) pounds. In order to remove the filled waste bag, a typical waste receptacle requires a user to vertically raise the filled waste bag until the bag has cleared the top of the waste receptacle. This task is made even more difficult because, typically, the user must extend at least one arm away from their body, and over the waste receptacle, in order to corral the top of the bag and vertically lift the filled waste bag.

A person's ability to perform activities of daily living (“ADL”) and instrumental activities of daily living (IADL), play a key role in determining the adaptive equipment that a person may need to live a full life. ADLs are a series of basic activities an individual must perform daily to live independently at home or in your community. ADLs are typically broken down into five categories: dressing and undressing; eating; maintaining continence; personal hygiene (showering, oral care, grooming, nail care, etc.); and transferring and mobility (standing, getting in/out of bed, walking independently, etc.). IADLs play a significant role in living independently but are not always required or done on a daily basis. The inability to perform IADLs frequently precedes an inability to perform ADLs. IADLs may be divided into seven categories: basic communication skills (phone, email, internet, etc.); household chores (laundry, vacuuming, dusting, dishes, etc.); managing personal finances (budgeting, paying bills, avoiding scams, etc.); meal preparation and planning; prescription management (correct doses, avoiding conflicts, getting refills, etc.); shopping for food and clothing; and transportation (driving, arranging rides, public transportation, etc.).

Adaptive equipment may be something as simple as a walker to make mobility possible or easier, or an amplification device for talking on the telephone or watching television. Adaptive equipment may be the difference between living independently and needing long-term care or home health care.

Traditional waste receptacles require users to remove trash bags by lifting them vertically from the top. This can be strenuous, resulting in bag tears, discomfort, and even physical injury. This problem is particularly significant for older adults, people with disabilities, and those with limited physical strength or mobility. As a result, a waste receptacle with front-opening doors that allow trash to be removed laterally rather than vertically can provide significant usability benefits. One deficiency of front-opening doors on waste receptacles is that they can be accidentally pulled open as trash is loaded into the garbage bag, which results in the unsightly garbage bag being visible and may release garbage odors into the air surrounding the waste receptacle. Finally, over time, the accidental opening of the doors may cause the doors to bend and warp in a way that diminishes the aesthetic appeal of the waste receptacle.

Thus, what is needed is an adaptive waste receptacle that improves a person's ability to perform IADLs.

### SUMMARY

To minimize the limitations in the prior art, and to minimize other limitations that will become apparent upon reading and understanding the present specification, the present disclosure discloses a new and useful daily adaptive waste receptacle with front doors that open horizontally and have unique closures, locks, and/or locking devices.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

To address the strenuous, and often challenging, task of vertically lifting a filled waste bag out of a waste receptacle, such as a garbage can, the daily adaptive waste receptacle of the present disclosure is configured to allow a user to remove a filled waste bag laterally. The daily adaptive waste receptacle of the present disclosure preferably does not require an individual to extend over the waste receptacle and lift the filled waste bag vertically upward. Adapting a waste receptacle to also open from the sides allows for the lateral removal of a waste bag. A waste receptacle adapted to have the waste bag removed laterally significantly reduces the difficulty in removing a filled waste bag from the receptacle, which in turn reduces the potential for strain or injury in performing the waste removal IADL.

The present disclosure discloses a new and adaptive apparatus for living independently. The adaptive waste receptacle may have a lateral opening that allows a filled waste bag to be removed laterally. This eliminates the need to vertically lift the filled waste bag over the top edge of the waste receptacle when changing waste bags.

The present disclosure also discloses a closure, lock, or locking device for vertically opening doors. Specifically, one embodiment of the present disclosure is a closure for an adaptive waste receptacle that secures the one or more front opening doors so that they do not open accidentally. The closure of the present disclosure may serve to hold the one or more doors securely in place, thereby counteracting the pressure exerted by filled trash bags against the doors, minimizing odor exposure, and maintaining aesthetic integrity (i.e.: trash bags not exposed through opening between doors and there is no warping/bending of the doors themselves).

Although one use of the adaptive waste receptacle of the present disclosure may be for the management and temporary storage of waste, it should be understood the adaptive waste receptacle may be used for any purpose, including the storage of objects that are not going to be recycled or thrown away.

One embodiment of the container may comprise one or more doors; a body; a cover; and a closure. The closure may comprise a pin, a pivot, a locking lever, and an actuator rod. The pin may extend upward from a distal end of the locking lever. The pivot may engage the locking lever. The pivot may engage a portion of the locking lever that is not the distal end of the locking lever nor a proximal end of the locking lever. The proximal end of the locking lever may engage a bottom end of the actuator rod. A top end of the actuator rod may engage the cover. The one or more doors may be rotatably attached to the body. The cover may be rotatably attached to the body. The one or more covers may be configured to rotate radially relative to the body. The container may comprise a rest configuration and an active configuration. The cover may be open when the container is in the active configuration. The pin may matingly engage the one or more doors when the container is in the rest configuration. The pin may not matingly engage the one or more doors when the container is in the active configuration. The one or more doors may be configured to be rotable only when the container is in the active configuration. The one or more doors may comprise an indentation configured to receive the pin. The container may further comprise a lid and the lid may be rotatably attached to a top portion of the cover. The container may comprise a pedal, and depressing the pedal may engage the active configuration, and releasing the pedal may engage the rest configuration. The container may comprise a tray; wherein the tray may be at an interior of a base of the body. The container may comprise a trash bag compartment that is on a rear side of the body and that comprises a dispensing port that is accessible from an interior of the body and a trash bag replacement port that is accessible from an exterior of the body. The trash bag compartment may be configured to accept from the exterior side of the body a replacement trash bag; and the trash bag compartment is configured to allow the replacement trash bag to be accessed from the dispensing port. The closure may comprise a biasing element. The closure pin may be slidably connected to at least one of the one or more doors, such that the closure pin slides in a vertical manner with respect to the one or more doors. The locking lever and the pivot may be substantially housed within a base of the body. Switching between the active configuration and the rest configuration may be accomplished via an electronic mechanism. The body may be a trapezoidal shape when viewed from above.

Another embodiment of the container may comprise one or more doors; a body; a cover; a closure; and a pedal. The closure may comprise a pin, a pivot, a locking lever, and an actuator rod. The pin may extend upward from a distal end of the locking lever. The pivot may engage the locking lever. The pivot may engage a portion of the locking lever that is not the distal end of the locking lever nor a proximal end of the locking lever. The proximal end of the locking lever may engage a bottom end of the actuator rod. A top end of the actuator rod may engage the cover. The container may comprise a rest configuration and an active configuration. The cover may be open when the container is in the active configuration. The pin may matingly engage the one or more doors when the container is in the rest configuration. The pin may not matingly engage the one or more doors when the container is in the active configuration. The one or more doors may be configured to be rotable only when the container is in the active configuration. Depressing the pedal may engage the active configuration, and releasing the pedal may engage the rest configuration. The one or more doors may comprise an indentation configured to receive the pin. The pedal may comprise an electrical motor to allow the lid or cover to be opened without a user physically engaging a portion or component of the container.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a front perspective view of one embodiment of an adaptive waste receptacle with the cover in an open position.

FIG. 2 is an illustration of a rear perspective view of one embodiment of an adaptive waste receptacle with the cover and lid both in a closed position.

FIG. 3 is an illustration of a side view of one embodiment of an adaptive waste receptacle with a cover that is in a partially open position.

FIG. 4 is an illustration of a side perspective view of one embodiment of an adaptive waste receptacle with both the lid and cover in a partially open position.

FIG. 5 is an illustration of a top interior view of one embodiment of an adaptive waste receptacle.

FIG. 6a is an illustration of a cross-section view of another embodiment of an adaptive waste receptacle with the cover in an open position and showing that a closure is disengaged, allowing the one or more front doors to be opened.

FIG. 6b is an illustration of a cross-section view of another embodiment of an adaptive waste receptacle with the cover in a closed position and showing that a closure is engaged and preventing the one or more front doors from being opened.

FIG. 7a is an illustration of a cross-section view of another embodiment of an adaptive waste receptacle with the cover in an open position and showing that a closure is disengaged, allowing the one or more front doors to be opened.

FIG. 7b is an illustration of a cross-section view of another embodiment of an adaptive waste receptacle with the cover in a closed position and showing that a closure is engaged and preventing the one or more front doors from being opened.

FIG. 8 is an illustration of a perspective view of another embodiment of an adaptive waste receptacle with two front doors in an open position and the cover in an open position.

FIG. 9 is an illustration of a perspective view of another embodiment of an adaptive waste receptacle with the two front doors in a closed position and the cover in an open position.

FIG. 10 is an illustration of a perspective view of another embodiment of an adaptive waste receptacle with the two front doors in a closed position and the cover in a closed position.

FIGS. 11a and 11b are illustrations of the dual panel double-pane doors of another embodiment of an adaptive waste receptacle showing internal structure support.

FIG. 12 is an illustration of a front perspective view of the dual panel double-pane doors of another embodiment of an adaptive waste receptacle showing a left door open.

FIG. 13 is an illustration of a front view of another embodiment of an adaptive waste receptacle with the left front door and the cover both in an open position.

FIG. 14 is an illustration of a top perspective view of another embodiment of an adaptive waste receptacle with the lid in an open position.

FIG. 15 is an illustration of a front perspective view of another embodiment of an adaptive waste receptacle with the cover in an open position.

FIG. 16 is an illustration of one embodiment of a closure.

FIG. 17 is an illustration of one embodiment of a portion of a closure.

FIG. 18 is an illustration of one embodiment of a portion of a closure.

FIG. 19 is an illustration of one embodiment of a portion of a closure.

FIG. 20 is a top perspective view of one embodiment of a locking container.

FIG. 21 is a bottom perspective view of the locking container.

FIG. 22 is a front view of the locking container.

FIG. 23 is a rear view of the locking container.

FIG. 24 is a left side view of the locking container.

FIG. 25 is a right side view of the locking container.

FIG. 26 is a top view of the locking container.

FIG. 27 is a bottom view of the locking container.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “sufficiently” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “brim lip” refers to any upper edge of anything hollow.

As used herein, the term “closure”, “lock”, or “locking mechanism” may be interchangeably used and they all refer to a mechanical system or device that fixes, or aids the fixation of, one or more doors in a closed or operating position. The closure may preferably be a device that prevents the accidental opening of the horizontal front doors of the adaptive waste receptacle.

As used herein, the term “receptacle” refers to an object, container, or space that used to contain something.

As used herein, the term “recycle” refers to the process of collecting and processing materials that would otherwise be thrown away as trash.

As used herein the term “waste” refers to any physical item, thing, or device that is not wanted and/or needed, and that is being disposed of.

As used herein the term “waste receptacle” refers to any container capable of containing waste and/or recyclable materials.

The adaptive waste receptacle of the present disclosure provides a solution for the strenuous and often arduous task of vertically lifting a filled waste bag out of a waste receptacle. The adaptive waste receptacle may have one, two, or more doors, including at least one that opens horizontally, such that the inner contents are exposed and/or accessible. The exposed contents may be laterally removed from the adaptive waste receptacle.

The adaptive waster receptacle of the present disclosure may preferably comprise one or more closures or locking mechanisms to securely hold the one or more horizontal and/or front-opening doors in place until such a time as the user wants them to open. Preferably there are two front doors, and they may form a substantial portion of the surface area of the front of the receptacle. As such, when the doors are open, the overall integrity of the receptacle is somewhat compromised, which is not a desirable state. The closure may assist one or more doors to counteract the pressure from filled or partially filled trash bags, ensuring the doors remain in a closed position, and the structure remains integrally intact. By securely locking the doors and preventing accidental openings, the waste receptacle of the present disclosure also minimizes odor exposure, such as from a tear in the bag or previous waste material being left in the waste receptacle. The closure preferably prevents the doors from bulging outward or opening under pressure, maintaining the visual appeal of the adaptive waste receptacle.

The closure may be user-friendly and be automatically engaged and/or disengaged depending on the position of the lid and/or cover. The closure may include an easy-to-use locking/unlocking interaction integrated into an existing trash bag removal flow without introducing an additional step or effort required to operate. This automatic engagement and/or disengagement of the closure caters to users with limited strength and/or dexterity as well as users simply seeking as much convenience as possible.

In an alternate embodiment, the closure may be manually and directly engaged or disengaged by a user.

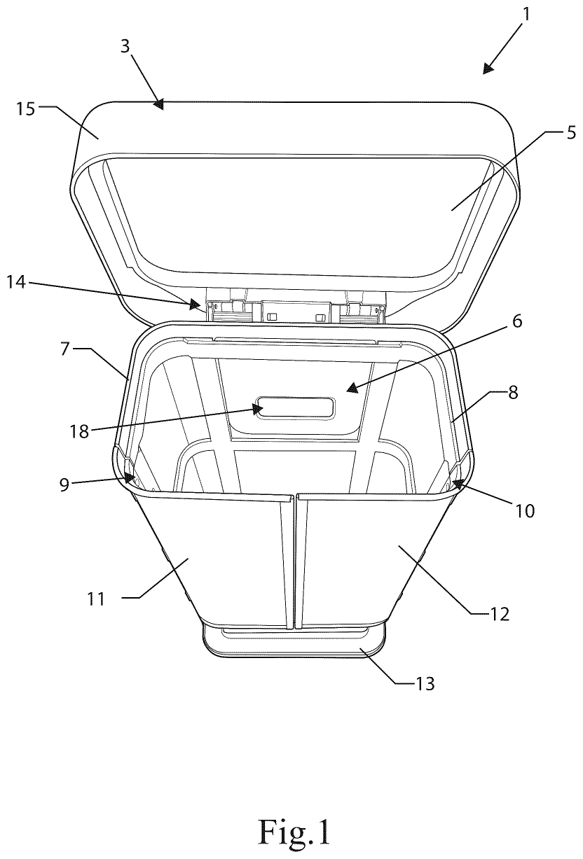

FIG. 1 is an illustration of a front perspective view of one embodiment of an adaptive waste receptacle with the cover in an open position. As shown in FIG. 1, adaptive waste receptacle 1 may comprise body 8, cover 3, lid 5, rim 7, trash bag compartment 6, dual-sided-hinged doors 11, 12, hinges 9, 10, and foot pedal 13. In some embodiments, the hinges may comprise a return so that the doors automatically return to a closed position after being opened. In alternate embodiments, adaptive waste receptacle 1 may be substantially any container that includes moving components, such as a storage container, laundry container, or other container type.

As shown in FIG. 1, body 8 may comprise a rear wall and two side walls that engage with and are connected to doors 11, 12 at hinges 9, 10. Body 8 may be constructed in a manner to support the weight of a waste bag as it is filled with refuse, waste, garbage, and/or materials to be recycled. In alternate embodiments the amount of weight to be supported may be variable, such as when used as a laundry container. Body 8 may be constructed to substantially support the weight of a filled waste bag when one or more of doors 11, 12 are in an open position.

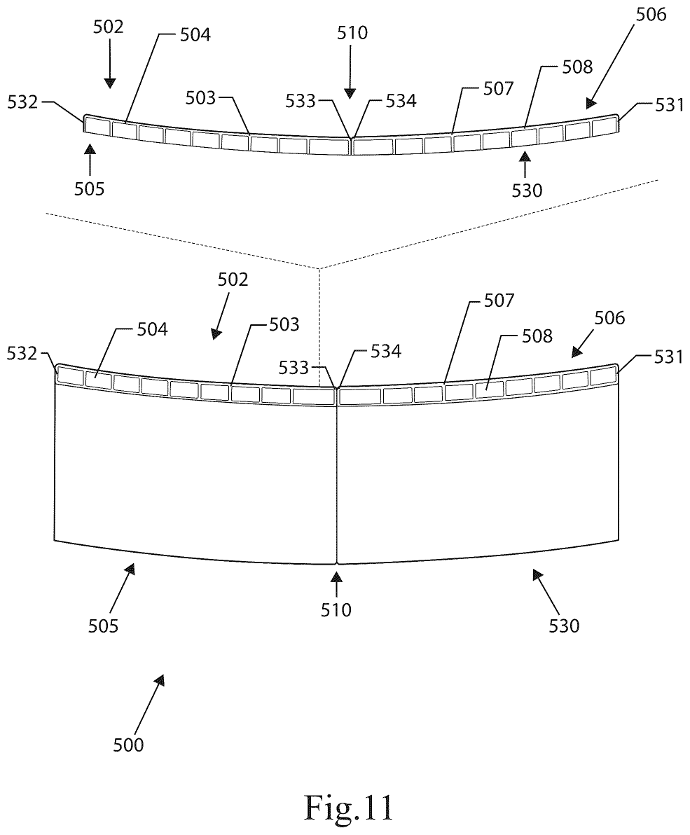

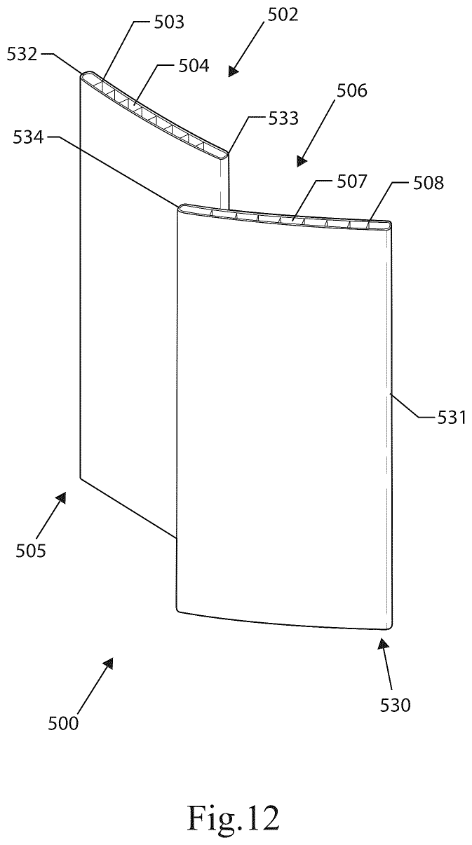

In one embodiment, adaptive waste receptacle 1 may be constructed using lightweight, thin, and strong materials, such as aluminum, composites, and/or plastic, but adaptive waste receptacle 1 may be constructed from any type of suitable material. The strength of a material may be compromised when manufactured using thinner dimensions or without supporting structures. Some lightweight polymers and other types of materials may not provide the structural support necessary to withstand the weight of a filled waste bag, or other materials. To construct adaptive waste receptacle 1 to support a filled waste bag, the body 8 and doors 11, 12 may be constructed as a double-pane system and associated supporting structures. Using a double-pane system may also provide additional cavities for locking mechanisms or closures. As shown in FIGS. 11a, 11b, and FIG. 12, a double-pane body may be formed by (1) manufacturing a plurality of exterior side walls and an exterior rear wall; (2) bonding the double-pane side walls and rear wall with an internal structure support; (3) and bonding an interior side wall and an interior rear wall to an internal structure support. A double-pane body may be configured in a manner to provide similar, if not greater, structural strength than a thicker or heavier material.

In various embodiments, body 8 may be a single unit or may be constructed from multiple portions. Body 8 and the other components of adaptive waste receptacle 1, including cover 3, lid 5, and doors 11, 12, may be made using injection molding techniques, welding metals, or being formed via other known manufacturing techniques. As shown in FIG. 1, adaptive waste receptacle 1 is generally a rounded rectangular shape. It should be understood that receptacle 1 may be any shape, including, but not limited to square, hexagonal, or other geometric shape, or cylindrical.

The top edge of body 8 and doors 11, 12, may form rim 7. Rim 7 may secure and/or retain a trash bag to the body 8 and/or keep it hidden. Rim 7 may also enhance the aesthetic of receptacle 1.

The doors 11, 12 may be attached to the side walls of body 8 via hinges 9, 10, such that the doors 11, 12 may rotate horizontally, or around the vertical axis, with respect to body 8. Each door 11, 12 may have an open position and a closed position. Doors 11, 12 may preferably be constructed in a manner to support the weight of a waste bag as a waste bag is filled. One or more side-hinged doors 11, 12 may be configured to be manually opened by a user or may be opened through an automatic actuating mechanism. Each door 11, 12 may have one two, three, or more hinges that attach it to body 8.

As shown in FIG. 1, cover 3 may comprise lid 5, which is preferably on a top portion of cover 3. Cover 3 may further comprise rim guard 15 and one or more cover hinges 14. As shown, rim guard 15 may be configured to matingly cover rim 7 when cover 3 is in a closed position. In this manner, rim guard 15 may keep a waste bag in place on rim 7. In some embodiments, rim guard 15 may preferably apply slight pressure on a waste bag against rim 7. Pressure applied by cover rim guard 15 against the inner portion of adaptive waste receptacle 1 may provide friction to hold the waste bag firmly in place as it is filled.

Cover 3 may be configured to be raised and lowered at cover hinge 14 relative to body 8. In a closed position, cover 3 may rest on top of rim 7 and may contact a waste bag or a separate liner ring.

In another embodiment, cover 3 may be configured to be raised and lowered manually by a user while lid 5 is operated via foot pedal 13. In other embodiments, there may be two (2) foot pedals, one that actuates lid 5 and the other that actuates cover 3.

Lid 5 may be configured to be vertically rotatably attached to cover 3 using one or more lid hinges. In some embodiments, the lid may be hingedly connected directly to body 8. In one embodiment, lid 5 is actuated to an open position from a closed position when a user steps on foot pedal 13. When the user removes their foot from stepping on foot pedal 13, lid 5 may return to a closed position. Preferably, the foot pedal 13 has an actuated position and a resting position. In alternative embodiments, the lid 5 may be removable or slidably engaged to the body 8.

Trash bag compartment 6, which may be configured to hold extra replacement waste bags, may comprise dispensing port 18, which may be accessible from an interior of the body 8. Trash bag compartment 6 may be sized to hold one or more extra replacement trash bags or an entire roll of replacement trash bags. The dispensing port 18 may be configured to allow a user to remove a single replacement trash bag from trash bag compartment 6 or tear a replacement trash bag from a roll of trash bags.

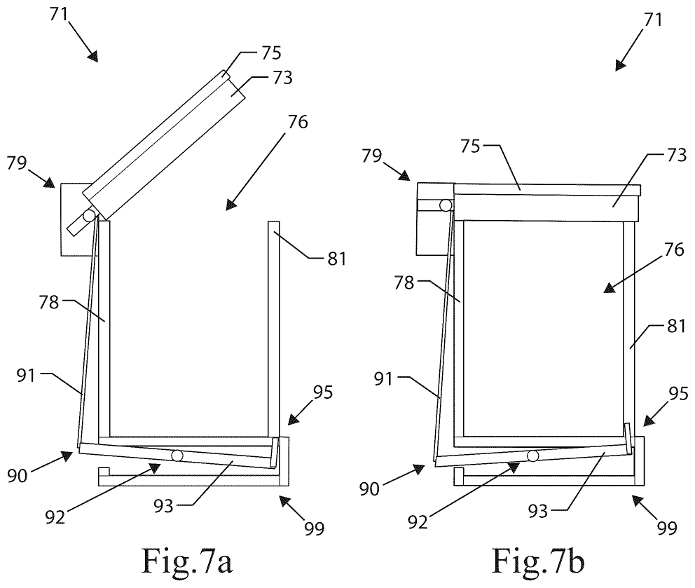

In some embodiments, the adaptive waste receptacle 1, may comprise an active configuration and a rest configuration. In one embodiment, when the foot pedal 13 is depressed and the lid 5 is open, this may be referred to as an active configuration. When the foot pedal 13 is not depressed and the lid 5 is closed, this may be referred to as a rest configuration. When in a rest configuration, the one or more doors 11, 12 may be restricted from opening, for example, by the structure shown in FIG. 7, hereinbelow. In alternative embodiments, other structures may be used to restrict opening of the doors 11, 12 when in a rest configuration.

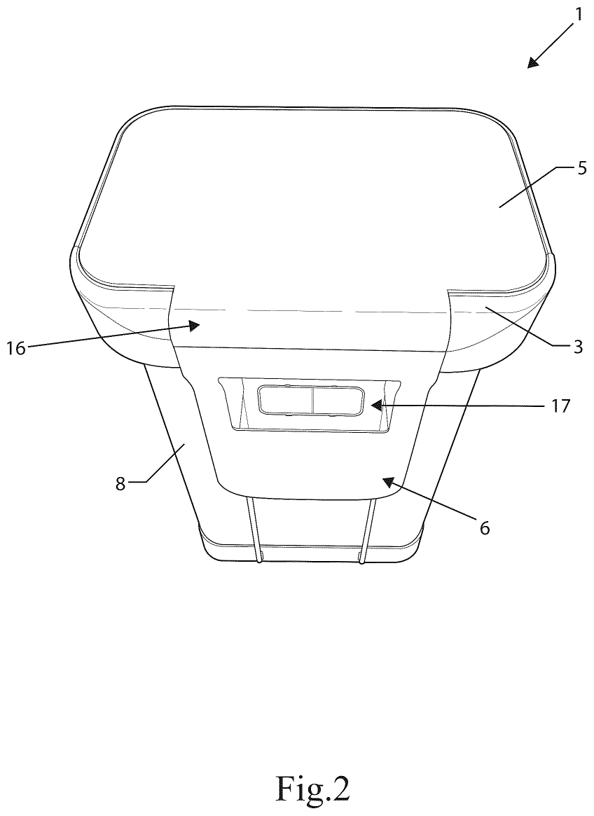

FIG. 2 is an illustration of a rear perspective view of one embodiment of an adaptive waste receptacle with the cover and lid both in a closed position. As shown, lid 5 may be matingly fitted within a top portion of cover 3 to have a symmetrical and aesthetically pleasing design. Lid 5 may be hingedly opened by stepping on foot pedal 13, which may rotate lid 5 vertically at lid hinge 16. FIG. 2 shows that trash bag compartment 6 may extend to the outer surface (or exterior) of body 8 and comprise trash bag compartment replacement port 17. Trash bag compartment replacement port 17 may be configured to allow a roll of trash bags to be stored in trash bag compartment 6.

Lid 5 may be hinged open when a user wants to dispose of waste, garbage, or refuse. This may preferably be done when cover 3 is in a closed position.

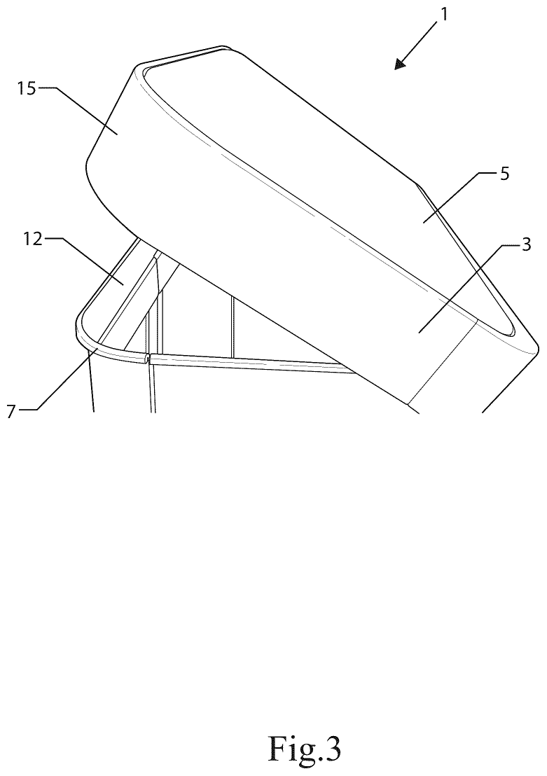

FIG. 3 is an illustration of a side view of one embodiment of an adaptive waste receptacle with a cover that is in a partially open position. As shown in FIG. 3, lid 5 and cover 3 may be simultaneously lifted, such that lid 5 remains in a closed position (relative to cover 3) and cover 3 is in an open position. FIG. 3 shows cover 3 in at least a partially open position. When cover 3 is put in an open position, rim 7 may be exposed and the rim guard 15 may be no longer blocking front door 12 from being opened. Preferably, the opening of cover 3 also disengages the closure, thereby allowing for contents of adaptive waste receptacle 1 to be removed horizontally. One embodiment of the closure is shown in FIG. 7.

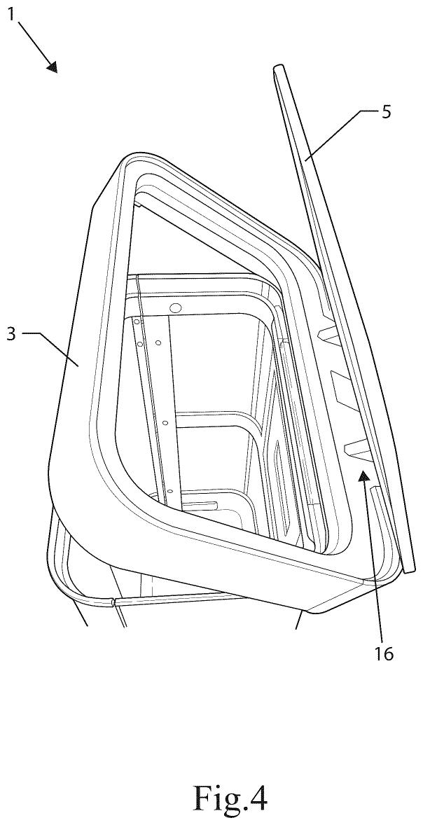

FIG. 4 is an illustration of a side perspective view of one embodiment of an adaptive waste receptacle with both the lid and cover in at least a partially open position. As shown in FIG. 4, lid 5 may hinge open from cover 3 at lid hinge 16.

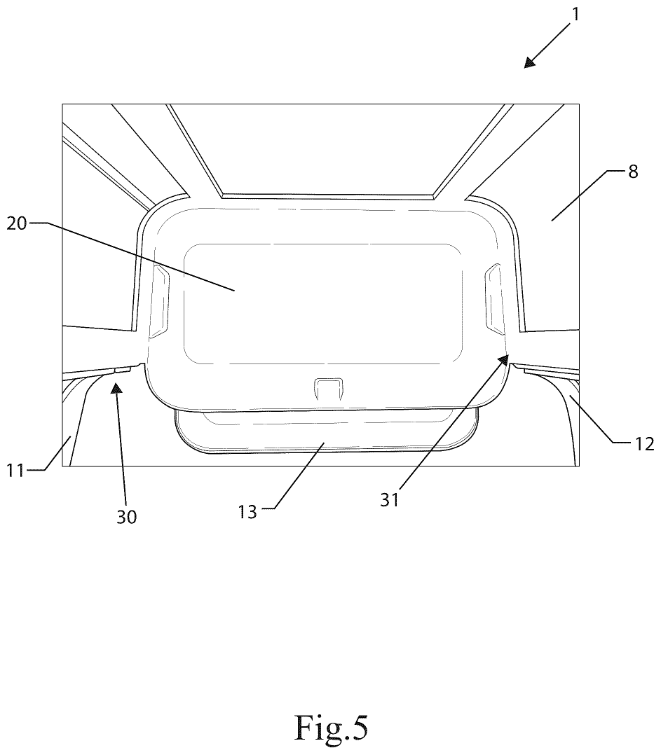

FIG. 5 is an illustration of a top interior view of one embodiment of an adaptive waste receptacle. As shown in FIG. 5, the bottom of adaptive waste receptacle 1 may comprise tray 20, which may catch and/or contain refuse and/or liquid that spills out of the installed waste bag. FIG. 5 also shows doors 11, 12 in an open position and shows hinges 30, 31. Tray 20 may be unitary with body 8 or may be a removeable portion, which provides for easier cleaning of tray 20. In some embodiments, tray 20 may be hollow to allow for structural components, such as those shown in FIG. 7, to be housed.

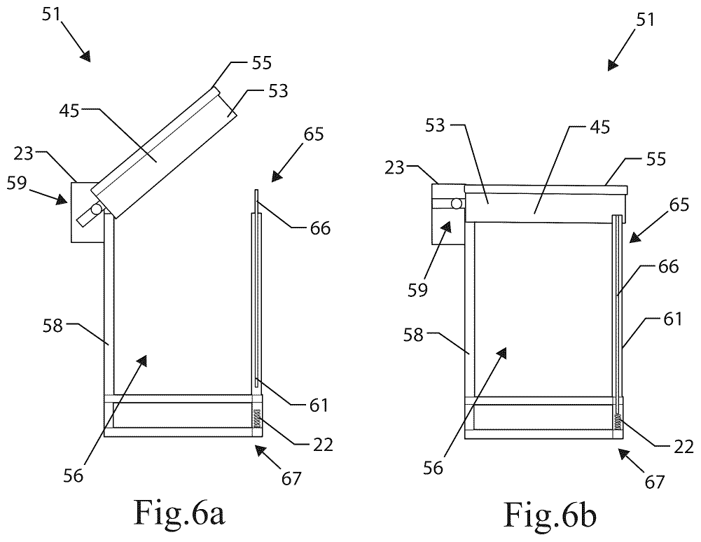

FIG. 6a is an illustration of a cross-section view of another embodiment of an adaptive waste receptacle with the cover in an open position and showing that a closure is disengaged, allowing the one or more front doors to be opened.

FIG. 6b is an illustration of a cross-section view of another embodiment of an adaptive waste receptacle with the cover in a closed position and showing that a closure is engaged and preventing the one or more front doors from being opened.

As shown in FIGS. 6a and 6b, adaptive waste receptacle 51 may comprise body 58, cover 53, rim guard 45, lid 55, interior space 56, cover hinge 59, door 61, closure 65, closure pin 66, and base 67. Closure 65 may comprise closure pin 66, which may be a wood, metal, or plastic bar, rod, dowl, latch, locking bar, bolt, and the like. Closure pin 66 may preferably be configured to slide, rotate, and/or be actuated in a vertical manner. Closure pin 66 may be slid manually, similar to a bolt lock, or may be actuated automatically in response to some action such as pressing a button or opening cover 53. Closure 65 may have two positions, an engaged position and a disengaged position. In some embodiments, closure pin 66 may be biased, such as by a spring structure. In one embodiment, the closure pin 66 may be biased upward, such that when the lid 55 is opened, the closure pin 66 may automatically raised and allow the door 61 to open. When the lid 55 is closed, the closure pin 66 may be pushed down to lock the door 61. In some embodiments, the biasing element may be housed within the base 67.

As shown in FIG. 6a, when cover 53 is in an open configuration, pin 66 of closure 65 may be configured to protrude from the top of door 61 and may be held in place by a spring or other type of tension device or biasing element. As shown in FIG. 6b, when cover 53 is in a closed position, cover 53 pushes down on pin 66, which overcomes the tension or force of the spring. The lower end of pin 66, which may be substantially contained within door 61, may then slide down into a cavity in base 67. In this manner, door 61 is prevented from being put in an open position. Door 61 is effectively locked in place by closure 65. When cover 53 is opened again, the spring may lift the pin 66 out of base 67, which allows door 61 to be opened. In this manner, door 61 is substantially prevented from being accidentally opened. In some embodiments, the pin may be coated or contoured for cosmetic purposes and to prevent snagging.

In one embodiment, door 61 and base 67 may be double-paned, such that pin 66 may slide in between the inner and outer panes. In other embodiments, pin 66 may be slidably fastened to the inner or outer surface of door 61. If fastened to the outside, pin 66 may be manually actuated. If on the inside, pin 66 may preferably be automatically actuated. Pin 66 may be in a groove or channel of door 61. The pin 66 may be biased upward by a biasing element 22.

In some embodiments, there may be one, two, three, four, or more closures. In other embodiments, there may be two doors, wherein closure 65 is attached to a first door, which, when closed may substantially prevent the second door from opening. In other embodiments, each door may have a closure and both closures may be simultaneously put in a disengaged position when said cover is lifted into an open position.

FIG. 6a shows closure 65 in an unlocked or disengaged position. FIG. 6b shows closure 65 in a locked or engaged position.

In other embodiments, base 67 may comprise a tray and the tray may act as the acceptor of pin 66 when closure 65 is in a locked position.

The adaptive waste receptacle may also comprise an electronic motor 23, or related electronic mechanism, that may function to raise and lower the lid 55.

FIG. 7a is an illustration of a cross-section view of another embodiment of an adaptive waste receptacle with the cover in an open position and showing that a closure is disengaged, allowing the one or more front doors to be opened.

FIG. 7b is an illustration of a cross-section view of another embodiment of an adaptive waste receptacle with the cover in a closed position and showing that a closure is engaged and preventing the one or more front doors from being opened.

As shown in FIGS. 7a and 7b, adaptive waste receptacle 71 may comprise body 78, cover 73, lid 75, interior space 76, cover hinge 79, door 81, closure 90, and base 99. Closure 90 may comprise closure pin 95, locking lever 93, pivot 92, actuator rod 91, which may be made from wood, metal, or plastic. Closure 90 may comprise closure pin 95, locking lever 93, pivot 92, and actuator rod 91.

Cover 73 may be configured to connect to or engage actuator rod 91. As cover 73 is rotatably raised (manually or automatically), a portion of cover 73 may pull up or otherwise actuate actuator rod 91. In turn, the pulling up of actuator rod 91 may cause locking lever 93 to pivot at pivot 92, such that closure pin 95 is lowered. When pin 95 is lowered, it may be no longer preventing door 81 from being opened. In some embodiments, this may be referred to as a rest configuration.

The actuator rod 91 may be a solid strut, bar, rod, or any other rigid part capable of transferring an up or down movement from cover 73 to locking lever 93 as cover 73 is hingedly or rotatably moved up or down. Locking lever 93 may be configured to rotatably attach to pivot 92.

In the open configuration shown in FIG. 7a, cover 73 is rotatably raised, and actuator rod 91 is moved upward, which may cause locking lever 93 to rotate about a pivot 92, which may then lower one or more closure pins 95 from door 81. In this configuration, door 81 may be released or unlocked, and allowed to rotate radially outward without being held in place by cover 73 or pin 95. In some embodiments, this may be referred to as an active configuration. In some embodiments, the pin 95 may matingly engage a divot, cavity, or receptacle within the door 81. In an alternative embodiment, the pin 81 may engage an outer surface of the door 81, such that rather than matingly engage an underside or interior of the door 81, the pin 81 blocks the door 81 from being able to be opened.

In the closed configuration shown in FIG. 7b, cover 73 is shown rotatably lowered down (closed), and a force pushes down on actuator rod 91, which transfers the downward force to one side of locking lever 93, which then rotates about a pivot 92, which then raises one or more closure pins 95 into a cavity, divot, or other structure within the door 81. In this configuration, door 81 may be locked or latched in place, and substantially prevented from rotating radially outward. In this manner, door 81 is prevented from being placed into an open position and is substantially prevented from being accidentally opened. Door 81 may be effectively locked in place by closure 90. When cover 73 is opened again, pin 95 may be actuated to be out of the way, which may allow door 81 to be opened.

FIG. 7a shows closure 90 in an unlocked position. FIG. 7b shows closure 90 in a locked or engaged position. Locking lever 93 may be substantially housed within base 99.

In alternative embodiments, the closure mechanism may be reversed by having the actuator rod 91 engage the lid at a different position, such an exterior end of the cover 73, such that then the cover 73 is open, the door 81 is prevented from opening, and when the cover 73 is closed, the door 81 may be opened.

In some embodiments, the closure 90 may be coupled or otherwise engage the same mechanism used to open the cover 73, such as having a foot pedal or motor

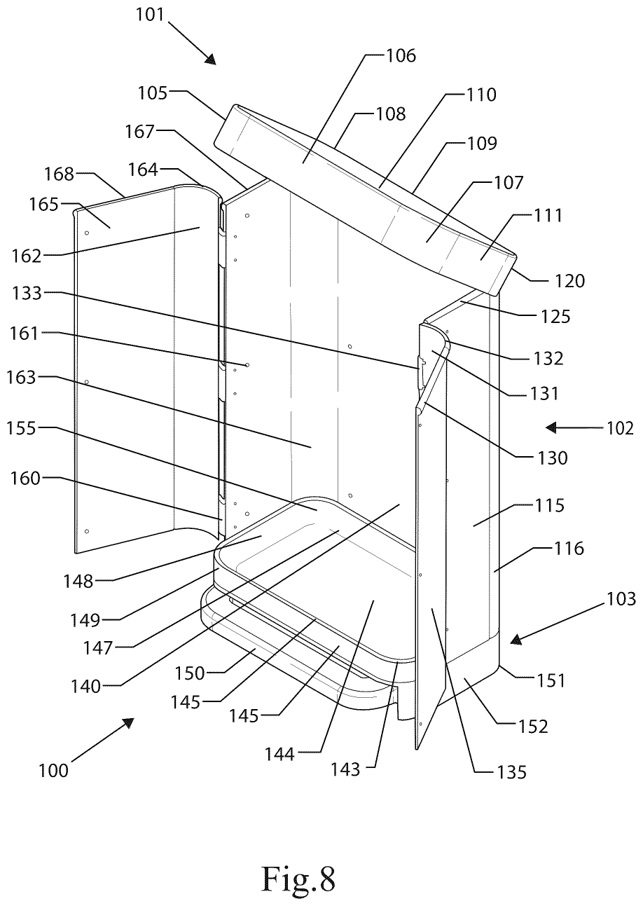

FIG. 8 is an illustration of a perspective view of another embodiment of an adaptive waste receptacle with two front doors in an open position and the cover in an open position. As shown in FIG. 8, adaptive waste receptacle 100 may comprise liner rim 101, body 102, base support 103, lid 110, right door 165, and left door 135. Lid 110 may be configured to be opened or closed against liner rim 101. Liner rim 101 may be configured to be raised or lowered above the top of body 102, right door 165, and left door 135. Body 102 may be configured to attach to base support 103. Right door 165 and left door 135 may be rotatably attached to body 102. Right door 165 and/or left door 135 may be configured to open and close against each other and base support 103. Right door 165 and/or left door 135 may be configured to open and expose the inner portion and contents of adaptive waste receptacle 100. Right door 165 and left door 135 configured in a closed position may block the free viewing of the internal portion and contents of adaptive waste receptacle 100. Right door 165 and left door 135 configured in a closed position may contain a waste bag held up by adaptive waste receptacle 100. Adaptive waste receptacle 100 may be configured with lid lever 150. Lid lever 150 may be configured to raise and lower lid 110 when actuated by lid lever 150. Base support 103 may be configured to support liner rim 101, body 102, lid 110 right door 165, left door 135, lid lever 150, and contents of adaptive waste receptacle 100. All associated components of adaptive waste receptacle 100 may be made from, but are not limited to, steel, plastic (such as, for example, polyethylene or polypropylene), wood, and/or wicker.

As shown in FIG. 8, liner rim 101 may comprise liner rim right front corner 105, liner rim front side 106, liner rim left front corner 107, liner rim left side 111, liner rim left rear corner 120, liner rim left rear corner 108 and liner rim rear side 109. Liner rim 101 may be configured to be raised and lowered relative to body 102. Liner rim 101 may rest against body right side brim lip 167, body left side brim lip 125, the right door brim lip, the left door brim lip 130, and the rear body side wall 140. Although not shown in FIG. 8, liner rim 101 may be rotatably attached at liner rim rear side 109 to adaptive waste receptacle 100 near the top of body rear side wall 140 using a hinge or multiple hinges not depicted in FIG. 8.

Another embodiment of liner rim 101 may be a single unit with associated components having been made using injection molding techniques, welding metals, or forming by any other material used to make liner rim 101.

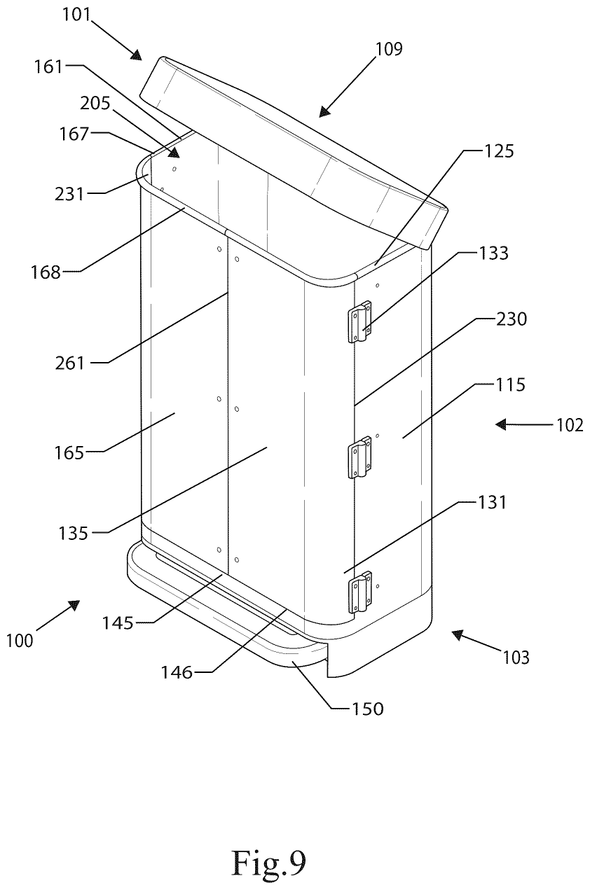

Liner rim 101 may be configured to lower and retain a waste bag against right door brim lip 168, right door corner brim lip 164, body right side brim lip 167, body rear right corner brim lip (not shown in FIG. 9), body rear side wall brim lip (not shown in FIG. 8), body rear left corner brim lip (not shown in FIG. 8), body left side brim lip 125, left door brim lip 130, and left door corner brim lip 132.

In another embodiment, liner rim 101 may be configured to lower and compress or seal against a separate liner ring. As a waste bag is compressed or sealed against a separate liner ring the waste bag may be held in place as additional waste is placed in the waste bag.

As shown in FIG. 8, body 102 may comprise body right side wall 161, body rear right corner 163, body rear side wall 140, body rear left corner 116, body left side wall 115. The top portion of each of body right side wall 161 may form body right side brim lip 167, body rear right corner 163 may form body rear right corner brim lip (not shown in FIG. 8), body rear side wall 140 may form body rear side wall brim lip (not shown in FIG. 8), body rear left corner 116 may form body rear left corner brim lip (not shown in FIG. 8), and body left side wall 115 may form body left side brim lip 125. Body right side brim lip 167, body rear right corner brim lip (not shown in FIG. 8), body rear side wall brim lip (not shown in FIG. 8), body rear left corner brim lip (not shown in FIG. 8), and body left side brim lip 125 may be configured to retain a waste bag as it is stretched, folded, or laid over body right side brim lip 167, body rear right corner brim lip (not shown in FIG. 8), body rear side wall brim lip (not shown in FIG. 8), body rear left corner brim lip (not shown in FIG. 8), and body left side brim lip 125. Body 102 may preferably be constructed in a manner to support the weight of a waste bag as it is filled. Body 102 may preferably be constructed to maintain the weight of a filled waste bag when right door 165, and/or left door 135 is in the open configuration.

Another embodiment of body 102 may be a single unit with associated components having been made using injection molding techniques, welding metals, or forming by any other material used to make body 102. Body 102 is not limited to the rectangular shape shown in FIG. 8 and may be, but is not limited to, a cylindrical shape.

As shown in FIG. 8, left door 135 may be attached to left door corner 131. Left door 135 and left door corner 131 may be configured to be rotatably attached to body left side wall 115 using a hinge or hinges. The top portion of left door 135 may form left door brim lip 130, and left door corner 131 may form left door corner brim lip 132. The left door brim lip 130 and left door corner brim lip 132 may be configured to retain a waste bag as it is stretched, folded, or laid over the left door brim lip 130 and left door corner brim lip 132. Left door corner 131 may be configured to rotatably attach to body left side wall 115 using a single left door hinge 133 or multiple individual hinges. Left door 135 may preferably be constructed in a manner to support the weight of a waste bag as a waste bag is filled. The left door 135 may be individually opened by a user or may be opened though some actuating mechanism.

Another embodiment of left door 135 and left door corner 131 may be a single unit with associated components having been made using injection molding techniques, welding metals, or forming by any other material used to make left door 135 and left door corner 131.

As shown in FIG. 8, right door 165 may be attached to right door corner 162. Right door 165 and right door corner 162 may be rotatably attached to body right side wall 161 using a hinge or hinges. The top portion of right door 165 may form right door brim lip 168, and right door corner 162 may form right door corner brim lip 164. Right door brim lip 168 and right door corner brim lip 164 may be configured to retain a waste bag as it is stretched, folded, or laid over right door brim lip 168 and right door corner brim lip 164. Right door corner 162 may be configured to rotatably attach to body right side wall 161 using a single right door hinge 160 or multiple individual hinges. Right door 165 may be individually opened by a user or may be opened though some actuating mechanism. Right door 165 may preferably be constructed in a manner to support the weight of a waste bag as a waste bag is filled.

Another embodiment of right door 165 and right door corner 162 may be a single unit with associated components having been made using injection molding techniques, welding metals, or forming by any other material used to make right door 165 and right door corner 162.

In another embodiment, right door brim lip 168, right door corner brim lip 164, body right side brim lip 167, body rear right corner brim lip (not shown in FIG. 8), body rear side wall brim lip (not shown in FIG. 8), body rear left corner brim lip (not shown in FIG. 8), body left side brim lip 125, left door brim lip 130 and left door corner brim lip 132 may be formed by a separate ring that may be installed around right door 165, right door corner 162, body right side wall 161, body rear right corner 163, body rear side wall 140, body left rear corner 116, body left side wall 115, left door corner brim lip 132, and left door 135. A separate ring may be a rubber or ring in the same shape and dimension as adaptive waste receptacle 100. A separate ring may be made of, but not limited to, rubber, silicone, nylon, or any other material that may add friction between a waste bag and adaptive waste receptacle 100. A separate ring may be configured to allow a waste bag to be folded or rolled over the separate ring. A separate ring may also compress a waste bag against the perimeter of adaptive waste receptacle 100.

As shown in FIG. 8, base support 103 may comprise base support pan 144, base support front left corner 143, base support front side 145, base support front right corner 149, base support right side 148, base support rear side 147, base support rear left corner 155, base support rear left corner 151, base support left side 152, and door sill 146. Base support 103 may be configured to attach to body 102 and support body 102, left door 135, right door, liner rim 101, and lid 110. Base support may further be configured to contain lid lever 150. Lid lever 150 may be configured to actuate lid 110 when depressed. Base support 103 may preferably be constructed in a manner to support liner rim 101, body 102, base support 103, lid 110, right door 165, left door 135, and a filled waste bag. Base support 103 may preferably be configured to support an empty adaptive waste receptacle 100 with either right door 165 or left door 135 or both right door 165 and left door 135 open in an upright manner. Base support 103 may preferably be configured to support a full adaptive waste receptacle 100 with either right door 165 or left door 135 or both right door 165 and left door 135 open in an upright manner.

Another embodiment of base support 103 may be a single unit with associated components having been made using injection molding techniques, welding metals, or forming by any other material used to make base support 103.

Although depicted as a rectangular shape adaptive waste receptacle 100 may also be cylindrical, trapezoidal, or substantial any other shape. The associated main components lid 110, liner rim 101, body 102, base support 103, right door 165, and left door 135 may be configured to support any other shape of adaptive waste receptacle 100.

FIG. 9 is an illustration of a perspective view of another embodiment of an adaptive waste receptacle with the two front doors in a closed position and the cover in an open position. Liner rim 101 may be rotatably attached to body 102 of adaptive waste receptacle 100 at liner rim rear side 109. With liner rim 101 raised, a waste bag may be installed in the interior portion of trash receptacle 205.

In one embodiment liner rim 101 may be attached using hinges. Although hinges may be used to rotatably attach liner rim 101 a person having ordinary skill in the art may appreciate that liner rim 102 may not be required to be attached using hinges. In another embodiment, liner rim 101 may be removably attached to allow removal of liner rim 101. Allowing removal may allow a waste bag to be evenly installed around left door 135, right door 165 and body 102.

In one embodiment, a separate ring (not shown) may retain a waste bag as it is rolled over the body left door brim lip 125, right door brim lip 168, body right side brim lip 167, and body left side brim lip 125. A separate ring may increase friction between liner rim 101 and body 102, right door 165 and left door 135 as liner rim 101 is lowered.

Left door 135 and left door corner 131 may be rotatably attached to body left side wall 115 using left door hinge 133 or multiple left door hinges 133. An attached left door 135 may be configured to have left door gap 230 that may allow left door 135 to freely open and close. An attached right door 165 may be configured to have right door gap 231 that may allow right door 165 to freely open and close. It may be preferable that front door gap 261 exists between right door 165 and left door 135 when closed. Front door gap 261 may allow for unimpeded movement of right door 165 and left door 135. In one embodiment, a single right door 165 or a single left door may be present, and a gap may be formed against another wall portion of adaptive waste receptacle 100. An astragal may be installed to allow the doors to have a physical stop and also provide a seal between the contents of the adaptive waste receptacle and the outside environment. The astragal may be made from rubber, silicone, Neoprene®, loop material, or any other material that provides a low friction contact surface. In another embodiment, a rubber type weather stripping may be installed on right door 165 and left door 135. A weather stripping may be rubber, silicone, Neoprene®, loop material, or any other material that provides a low friction contact surface. Right door 165 may be rotatably attached to body right side wall 161 using a hinge, such as right door hinge 160 or multiple right door hinges 160 as shown in FIG. 8. An attached right door 165 may be configured to have right door gap 231 that may allow the door to freely open and close.

Base support front side 145 of base support 103 may form a seal between door sill 146 and right door 165 and left door 135. Door sill 146 may have a contact surface with right door 165 and left door 135. Door sill 146 may comprise a weather stripping made from but not limited to rubber, silicone, Neoprene®, loop material, or any other material that provides a low friction contact surface.

An adaptive waste receptacle 100 configured with left door 135 and right door 165 closed against each other allows liner rim 101 to be raised allowing for a waste bag to be installed. In right door 165 and left door 135 closed configuration there may be a slight front door gap 261 to allow the doors to freely open.

In one embodiment a separate lever, similar to lid lever 150, may be used to actuate right door 165 and/or left door 135. In another embodiment, right door 165 and/or left door 135 may be actuated automatically using any type of struts, pistons, gears, motors, or any other mechanism for actuating right door 165 and/or left door 135 open and closed.

In one embodiment, liner rim 101 may be raised and lowered using a separate lever or may be actuated automatically using any type of struts, pistons, gears, motors, or any other means for actuating liner rim 101.

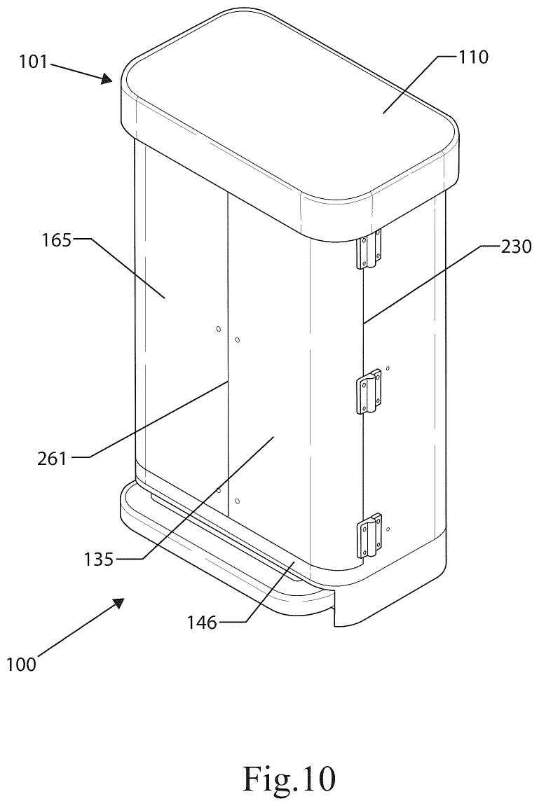

FIG. 10 is an illustration of a perspective view of another embodiment of an adaptive waste receptacle with the two front doors in a closed position and the cover in a closed position. As shown in FIG. 10, adaptive waste receptacle 100 is shown with lid 110, liner rim 101, right door 165, and left door 135 in a closed configuration. In a closed configuration the contents of an adaptive waste receptacle 100 are preferably not viewable. Lid 110, liner rim 101, front door gap 261, right door gap 231 as shown in FIG. 9, left door gap 230, and door sill 146 may form a gas barrier that prevents odors from escaping the waste bag within adaptive waste receptacle 100.

FIGS. 11a and 11b are illustrations of the dual panel double-pane doors of another embodiment of an adaptive waste receptacle showing internal structure support. Double-pane French door 500 may comprise right door inside panel 502, right door internal structure void 504, right double-pane door internal structure support 503, French door gap 510, right double-pane door gap end 533, left double-pane door gap end 534, left double-pane door internal structure support 507, left door internal structure void 508, left door inside panel 506, left double-pane door end 531, left door external panel 530, right door external panel 505. An adaptive waste receptacle with French doors may benefit from the use of a double-pane system. Adaptive waste receptacle 100 may be constructed in a manner to support the weight of a filled waste bag, which may be excessively heavy. It is well known that the strength of structural materials is compromised as structural materials are manufactured using thinner dimensions. Many lightweight polymers also do not provide the structural support necessary to withstand the weight of a filled waste bag. In order to construct adaptive waste receptacle 100 in a manner to support a filled waste bag and also not suffer from excessive weight is to manufacture panels using double-pane system and supporting structures. Alternate embodiments of receptacle 100 may use a single-pane system.

Double-pane French doors 500 manufactured using thin, light weight, and sufficiently weaker materials may provide the similar or increased structural strength by adding right double-pane door internal structure support 503 and left double-pane door internal structure support 507. Double-pane French door 500 may be formed by (1) manufacturing right door inside panel 502 and left door inside panel 506; (2) bonding right double-pane door internal structure support 503 and left double-pane door internal structure support 507 to right door inside panel 502 and left door inside panel 506; (3) bonding right door external panel 505 and left door external panel 530 to right double-pane door internal structure support 503 and left double-pane door internal structure support 507; (4) affixing left double-pane door end 531 and right door end 532. Right double-pane door internal structure support 503 and left double-pane door internal structure support 507 may preferable be configured in a manner to provide similar, if not greater, structural strength than a thicker stronger material used when bonded to right door inside panel 502, right door external panel, left door inside panel 506 and left door external panel 530. Right double-pane door internal structure support 503 and left double-pane door internal structure support 507 may preferably be configured to create right door internal structure void 504 and left door internal structure void 508. Configuring double-pane French door 500 to include right door internal structure void 504 and left door internal structure void 508 reduces the weight of an adaptive waste receptacle without compromising structural strength. A French door gap 510 may allow double-pane French door 500 to freely open and close.

As shown in FIG. 9, the right door internal structure void 504 and left door internal structure void 508 may be uniform voids that may be configured to minimize the weight of double-pane French door 500. Right double-pane door internal structure support 503 and left double-pane door internal structure support 507 may be uniformly spaced or appropriately spaced to vary the location of the structural support of right door external panel 505 and left door external panel 530.

Right double-pane door internal structure support 503 and left double-pane door internal structure support 507 are perpendicular to a respective right door inside panel 502 right door external panel 505 and left door inside panel 506 left door external panel 530. Right double-pane door internal structure support 503 and left double-pane door internal structure support 507 may also benefit from a different angle or nonuniform distribution throughout the double-pane configuration.

In another embodiment, double-pane French door 500 may also comprise an astragal. An astragal may be installed to allow the doors to have a physical stop, provide a seal between the contents of the adaptive waste receptacle and the outside environment, and may be used to further conceal the content within adaptive waste receptacle 100. An astragal may be a piece of hardware used on a pair of French doors 500 when closed. In the event of a spill within adaptive waste receptacle 100 an astragal may seal with the adaptive waste receptacle any liquid, odor, and keep out insects and other pests. In another embodiment, a rubber type weather stripping may be installed on right door inside panel 502 and left door inside panel 506. A weather stripping may be rubber, silicone, Neoprene®, loop material, or any other material that provides a low friction contact surface.

Right door internal structure void 504 and left door internal structure void 508 may be non-uniform and may also vary along the length of right double-pane door internal structure support 503 and left double-pane door internal structure support 507.

FIG. 12 is an illustration of a front perspective view of the dual panel double-pane doors of another embodiment of an adaptive waste receptacle showing a left door open. As shown in FIG. 12, left door external panel may rotate radially outward from adaptive waste receptacle 100. As shown, when the door of the adaptive waste receptacle is open, the contents of adaptive waste receptacle 100 may be exposed and removed.

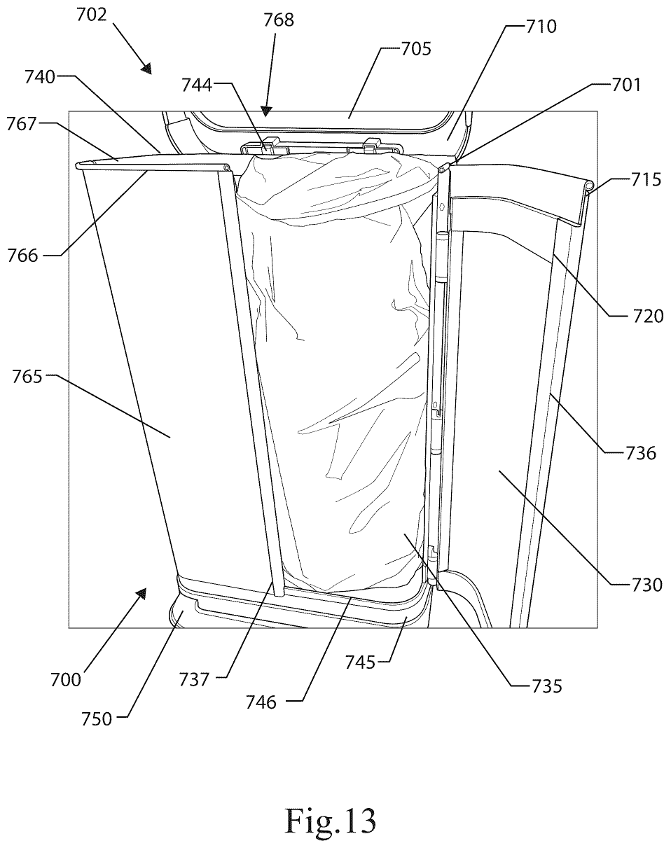

FIG. 13 is an illustration of a front view of another embodiment of an adaptive waste receptacle with the left front door and the cover both in an open position. Another embodiment may comprise adaptive waste receptacle 700 constructed of stainless steel. A stainless-steel adaptive waste receptacle may comprise lid 705, inner liner rim receptacle channel 710, left side brim lip 701, left door brim lip 715, left inner door reenforcing structure 720, left door seal 736, left door 730, waste bag 735, base support 745, door sill seal 746, right door astragal and seal 737, right door 765, lid lever 750, right side brim lip 766, liner rim hinge 744. Although a light, but strong material is preferred, such as thin stainless-steel or aluminum, any material or metal alloy may be used.

Liner rim 702 may be constructed from a polymer but may also be constructed from a similar metal or alloy. The bottom of liner rim 702 may be configured with an inner liner rim receptacle channel 710. An inner liner rim receptacle channel may be configured to accept right door brim lip 766, right-side brim lip 767, body rear side wall 740, left side brim lip 701, left door brim lip 715. An inner liner rim receptacle channel may be formed using a waste bag compression wall 768. A waste bag compression wall may be a protrusion of liner rim 702. A waste bag compression wall 768 may partially or completely apply slight pressure on a waste bag 735 against right door brim lip 766, right side brim lip 767, body rear side wall 740, left side brim lip 701, left door brim lip 715. Pressure applied by liner rim 702 against the inner portion of adaptive waste receptacle 700 provides additional friction force to hold the waste bag 735 as a waste bag 735 is filled.

As shown in FIG. 13, liner rim hinge 744 may comprise multiple hinges or a single hinge. Liner rim hinge 744 may allow liner rim 702 to rotate radially up and behind adaptive waste receptacle 700. As liner rim 702 may rotate radially up and behind a waste bag 735 may be replaced.

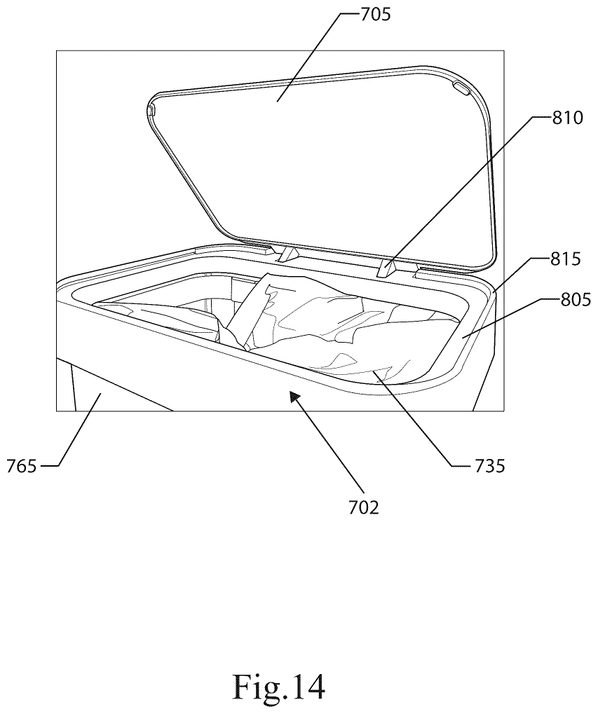

FIG. 14 is an illustration of a top perspective view of another embodiment of an adaptive waste receptacle with the lid in an open position. Liner rim 702 may be configured to be rotatably attached to lid 705. Lid 705 may be attached using lid hinge 810 or as shown multiple lid hinges 810. Lid 705 may be configured to rest on liner rim lid lip 805. Liner rim 702 may be configured to have liner rim brim 815 that may be formed on the outer surface area of liner rim lid lip 805. Liner rim brim 815 may also be configured to reduce limited spilling from adaptive waste receptacle 100.

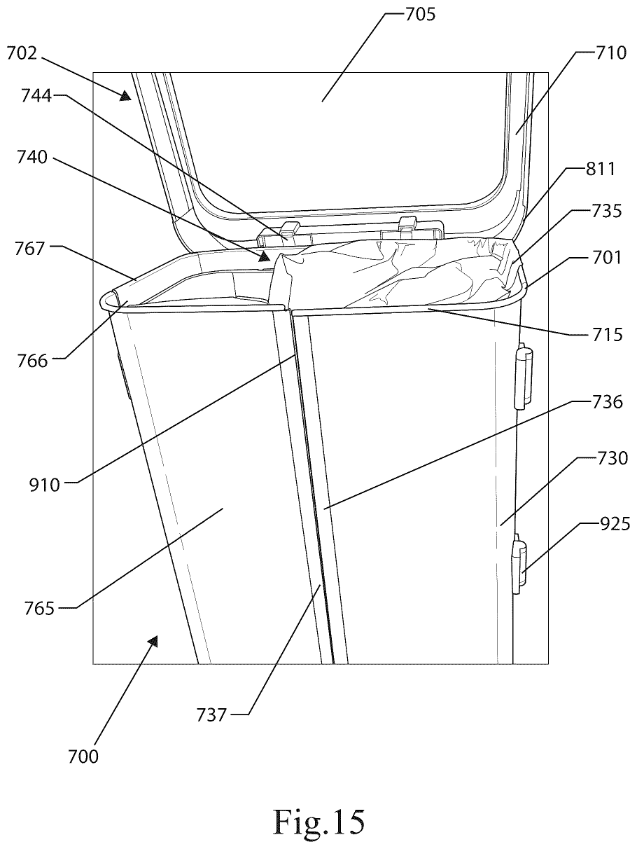

FIG. 15 is an illustration of a front perspective view of another embodiment of an adaptive waste receptacle with the cover in an open position. Adaptive waste receptacle 700 may be configured with liner rim 702 raised, right door 765 and left door 930 closed. As shown in FIG. 15, lid 705 may engage with liner rim 702 as liner rim 702 is rotatably raised. Liner rim hinge 744 may rotatably attach a liner rim 702 to body rear side wall 740. Liner rim hinge 744 may include multiple liner rim hinges 744 and are preferably configured to support liner rim 702 and lid 705.

As shown in FIG. 15, a waste bag 735 may be installed and rolled over left side brim lip 701 and body rear side wall. As further shown, a waste bag 735 if not rolled on right door brim lip 766, right side brim lip 767, body rear side wall 740, left side brim rim 701, and left door brim lip 715, may inadvertently fall into adaptive waste receptacle 700. An inner liner rim receptacle channel 710 may provide additional compressive force against a waste bag 735 to further hold up the waste bag 735 as it is filled.

Left front door seal 736 and right door astragal and seal 737 may be configured to have gap 910. A small gap 910 may allow left door 730 and right door 765 to freely rotate radially open and close. Left door seal 736 may seal against the right door astragal (or vice versa) and seal 737 concealing the contents of adaptive waste receptacle 700.

As shown in FIG. 15, adaptive waste receptacle 700 may have multiple hinges 925 and may be configured to use a single hinge 925. It is preferable that any hinges 925 be constructed of similar and durable materials to support left door 730 and right door 765 as the doors are open and closed and also as a waste bag 735 is filled. In some embodiments, the doors may use soft close technology. In some embodiments, the hinges may have returns.

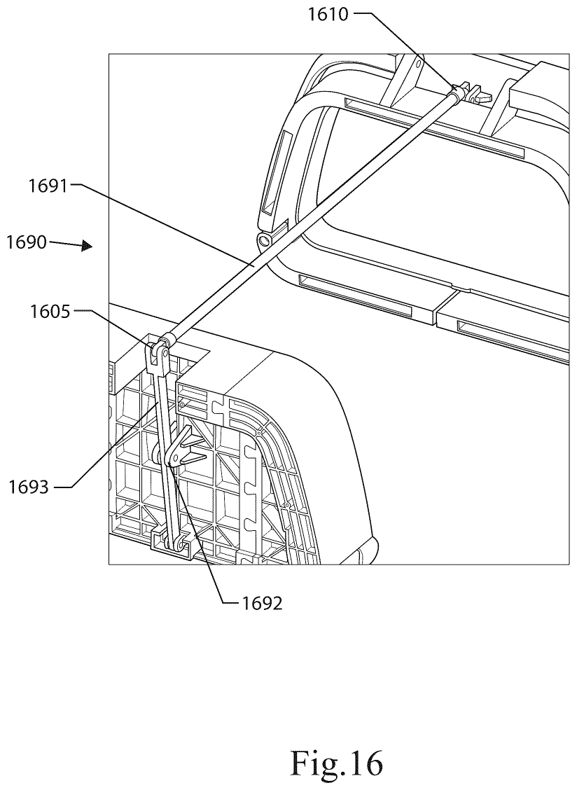

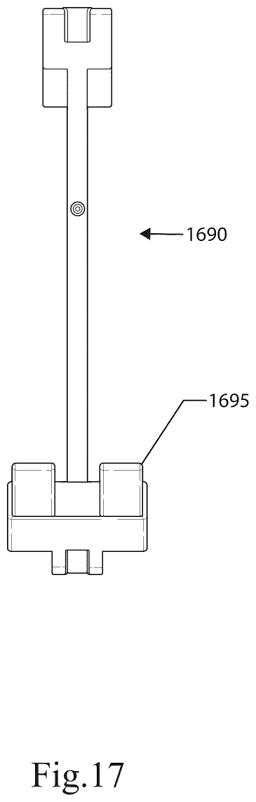

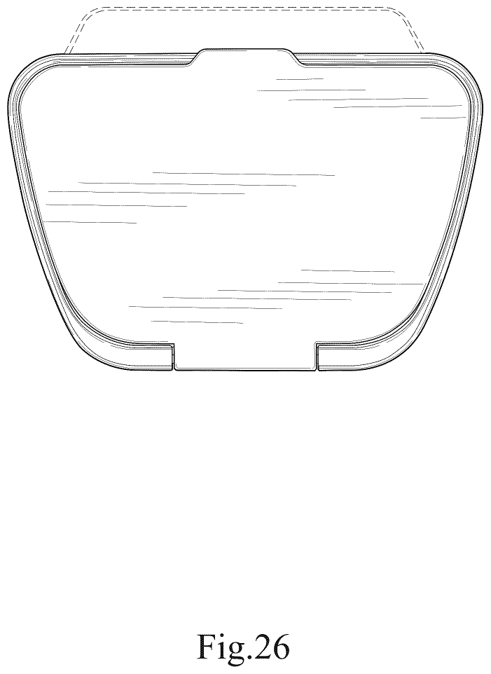

FIG. 16 is an illustration of one embodiment of a closure. As shown in FIG. 26, the closure 1690 may comprise closure pin 1695 (shown in FIG. 17), locking lever 1693, pivot 1692, and actuator rod 1691. The locking lever 1693 and actuator rod 1691 may be hingedly connected by a lower hinge 1605, and the actuator rod 1691 and lid may be hingedly connected by an upper hinge 1610. In alternate embodiments, either the lower hinge 1605 and the lower hinge 1610 may be fixed joints, such that they do not allow hinged movement. In alternate embodiments, both the lower hinge 1605 and the lower hinge 1610 may be fixed joints, such that they do not allow hinged movement.

FIG. 17 is an illustration of one embodiment of a portion of a closure. As shown in FIG. 17, the closure may have two upward protrusions, which may be configured to engage two doors, such that each protrusion engages one door.

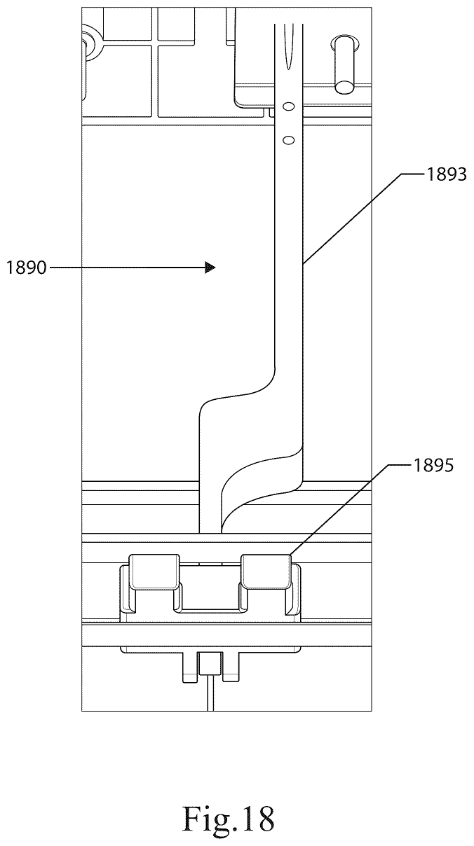

FIG. 18 is an illustration of one embodiment of a portion of a closure. As shown in FIG. 18, the pin 1895 may have two upward protrusions, which may be configured to engage two doors, such that each protrusion engages one door. Also, the closure 1890 may comprise a locking lever 1893 that has a curve, rather than purely linear, such as the locking lever 1693 shown in FIG. 16. This locking lever 1893 may allow for the inclusion of additional components or be configured to avoid existing components.

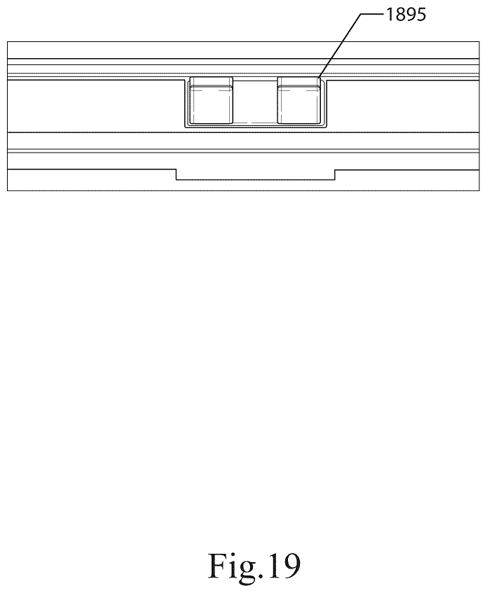

FIG. 19 is an illustration of one embodiment of a portion of a closure. As shown in FIG. 19, the pin 1895 may have two upward protrusions, which may be configured to engage two doors, such that each protrusion engages one door.

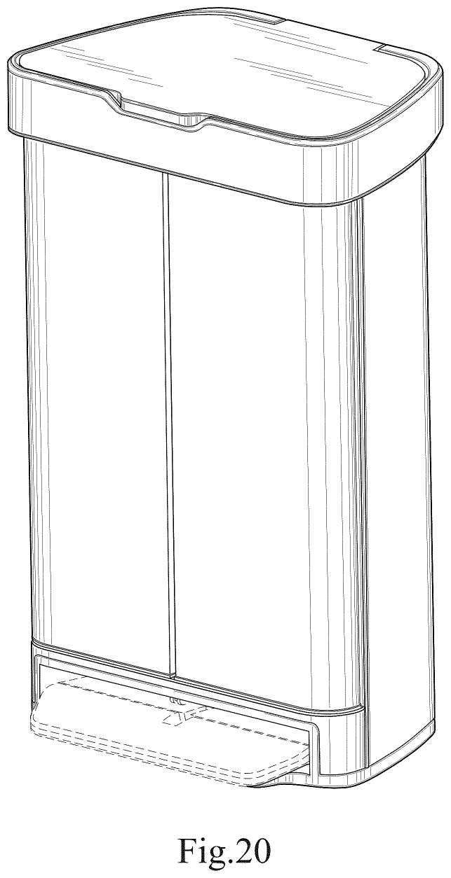

FIG. 20 is a top perspective view of one embodiment of a locking container. As shown in FIG. 20, the locking container may be substantially trapezoidal in shape. In a preferred embodiment, the user may step on the pedal in order to cause the lid to open. In a preferred embodiment, when the lid is in an open configuration, the doors may be unlocked and able to be opened, such as for removal of contents.

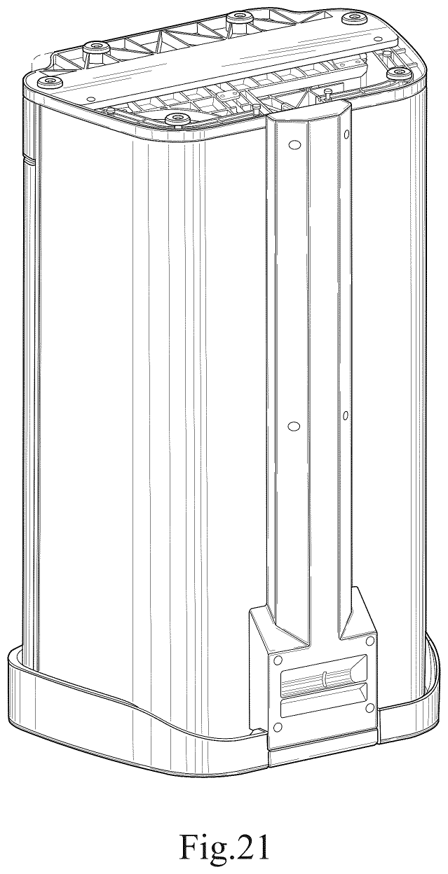

FIG. 21 is a bottom perspective view of the locking container.

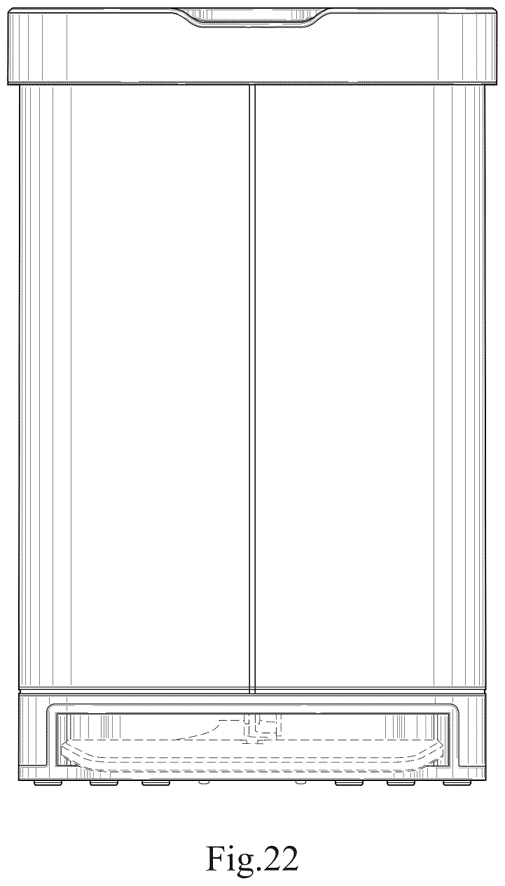

FIG. 22 is a front view of the locking container.

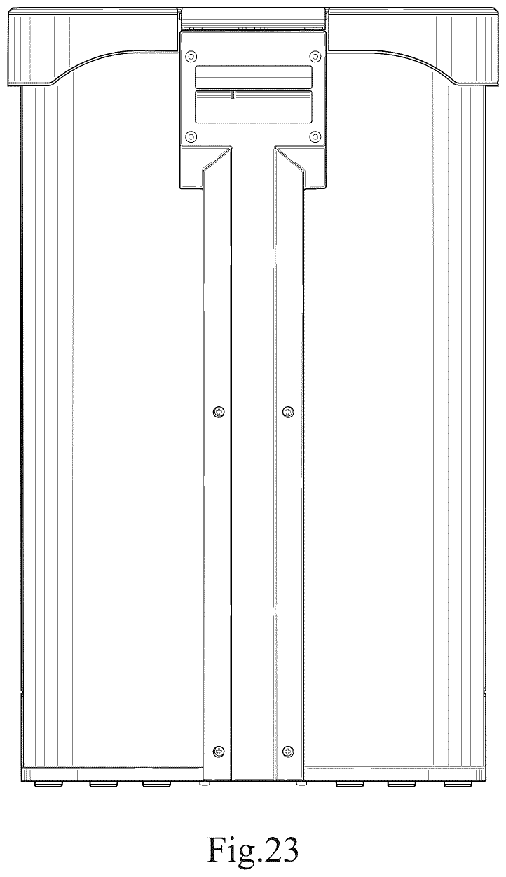

FIG. 23 is a rear view of the locking container.

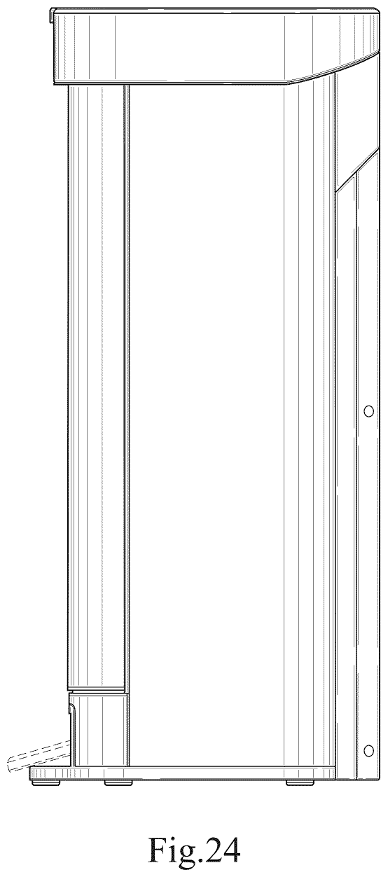

FIG. 24 is a left side view of the locking container.

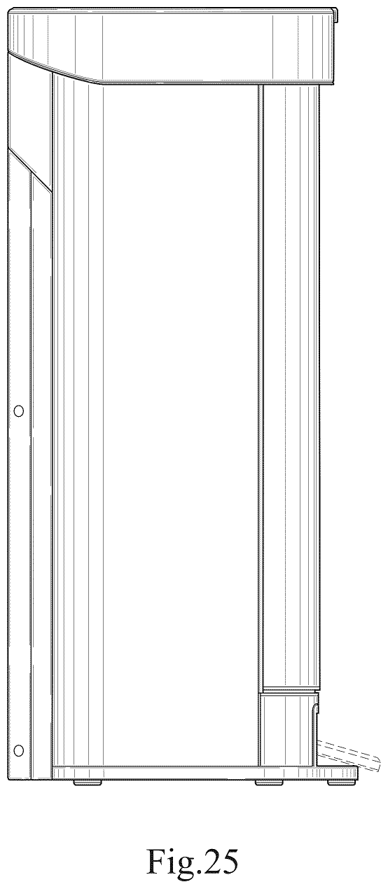

FIG. 25 is a right side view of the locking container.

FIG. 26 is a top view of the locking container.

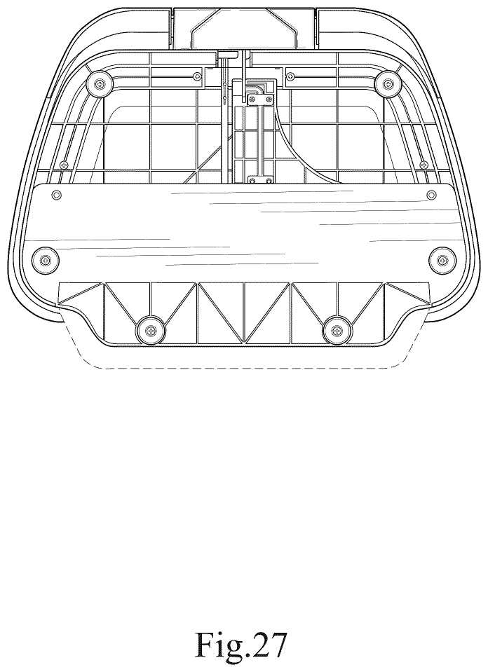

FIG. 27 is a bottom view of the locking container.

Unless otherwise stated, all measurements, values, ratings, positions, magnitudes, sizes, locations, and other specification gaps that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A container comprising:
one or more doors;
a body;
a cover; and
a closure;
wherein said closure comprises one or more pins, a pivot, a locking lever, and an actuator rod;
wherein said one or more pins extend upward from a distal end of said locking lever;
wherein said pivot engages said locking lever at a portion of said locking lever other than said distal end of said locking lever and other than a proximal end of said locking lever;
wherein said proximal end of said locking lever engages a bottom end of said actuator rod;
wherein a top end of said actuator rod engages said cover;
wherein said one or more doors are rotatably attached to said body;
wherein said cover is rotatably attached to said body;
wherein said cover is configured to rotate radially relative to said body;
wherein said container is configured to switch between two configurations: a rest configuration and an active configuration;
wherein when said container is in said active configuration said cover is in an open position;
wherein said one or more pins are configured to matingly engage said one or more doors when said container is in said rest configuration, such that said one or more doors are prevented from opening; and
wherein said one or more pins are configured to be disengaged from said one or more doors when said container is in said active configuration, such that said one or more doors are rotatable.

2. The container of claim 1, wherein at least one of said one or more doors comprise an indentation configured to receive said one or more pins.

3. The container of claim 1, further comprising:
a lid;
wherein said lid is rotatably attached to a top portion of said cover.

4. The container of claim 1, further comprsing:
a pedal;
wherein depressing said pedal engages said active configuration, and releasing said pedal engages said rest configuration.

5. The container of claim 1, further comprising:
a tray;
wherein said tray is at an interior of a base of said body.

6. The container of claim 1, further comprising:
a trash bag compartment that is on a rear side of said body and that comprises a dispensing port that is accessible from an interior of said body and a trash bag replacement port that is accessible from an exterior of said body.

7. The container of claim 6, wherein said trash bag compartment is configured to accept from said exterior side of said body a replacement trash bag; and
wherein said trash bag compartment is configured to allow said replacement trash bag to be accessed from said dispensing port.

8. The container of claim 2, wherein said closure further comprises a biasing element.

9. The container of claim 8, wherein said one or more pins slidably engage with said at least one indentation of said one or more doors, such that said one or more pins slide in a vertical manner with respect to said one or more doors.

10. The container of claim 9, wherein said locking lever and said pivot are substantially housed within a base of said body.

11. The container of claim 1, wherein switching between said active configuration and said rest configuration is via an electronic mechanism.

12. The container of claim 1, wherein said body is a substantially a rounded trapezoidal shape when viewed from above.

13. The container of claim 10, wherein said one or more doors are two doors and wherein said one or more pins are two pins, one for each of said two doors.

14. A container comprising:
one or more doors;
a body;
a cover;
a closure; and
a pedal;
wherein said closure comprises a pin, a pivot, a locking lever, and an actuator rod;
wherein said one or more pins extend upward from a distal end of said locking lever;
wherein said pivot engages said locking lever;
wherein said pivot engages a portion of said locking lever other than said distal end of said locking lever and other than a proximal end of said locking lever;
wherein said proximal end of said locking lever engages a bottom end of said actuator rod;
wherein a top end of said actuator rod engages said cover;
wherein said container comprises a rest configuration and an active configuration;
wherein said cover is in an open position when said container is in said active configuration; wherein said one or more pins are configured to matingly engage said one or more doors when said container is in said rest configuration; wherein said one or more pins do are configured to be disengaged from said one or more doors when said container is in said active configuration; wherein said one or more doors are configured to be rotable only when said container is in said active configuration; wherein depressing said pedal engages said active configuration, and releasing said pedal engages said rest configuration; and
wherein said one or more doors comprise an indentation configured to receive said pin.

15. The container of claim 14, wherein said pedal comprises an electrical motor.

16. The container of claim 14, wherein said body is a substantially rounded trapezoidal shape when viewed from above.

17. The container of claim 14, wherein at least one of said one or more doors comprise an indentation configured to receive said one or more pins.

18. The container of claim 17, wherein said one or more pins slidably engage with said at least one indentation of said one or more doors, such that said one or more pins slide in a vertical manner with respect to said one or more doors.

19. The container of claim 18, wherein said one or more doors are two doors and wherein said one or more pins are two pins, one for each of said two doors.
